(19) United States
(12) Patent Application Publication
(10) Pub. No.: US 2008/0046743 A1
(43) Pub. Date: Feb. 21, 2008

(54) SYSTEM AND METHOD FOR AUTOMATICALLY SIGNING ELECTRONIC DOCUMENTS

(75) Inventors: CHUNG-I LEE, Tu-Cheng (TW); HAI-HONG LIN, Shenzhen (CN); GUO-LING OU-YANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,803

(22) Filed: Dec. 9, 2006

(30) Foreign Application Priority Data
Aug. 16, 2006 (CN) 200610062141.1

(51) Int. Cl. H04L 9/00

(52) U.S. Cl. 713/176

(57) ABSTRACT

A computer-based method for automatically signing electronic documents is disclosed. The method includes the steps of: creating an electronic document, and notifying a specified signer to digitally sign the electronic document; confirming whether or not to digitally sign the electronic document; obtaining a copy of a digital certificate of the specified signer if it is confirmed to digitally sign the electronic document, the digital certificate comprising a private key; verifying the identity of the specified signer according to the digital certificate; generating a message digest of the electronic document if the identity of the specified signer has been verified; and encrypting the message digest with the private key thereby yielding a digital signature of the electronic document. A related system is also disclosed.

### BACKGROUND OF THE INVENTION

1. Field of the Invention

The present invention is related to a system and method for automatically signing electronic documents.

2. Description of related art

Usually, electronic documents are printed with paper for applying a handwritten signature. This kind of operation increases the cost and impairs the efficiency of a business. If a country has enacted the digital signature law, a digital signature would have legal effect just as the handwritten signature, and the digital signature would be used as evidence. Confidentiality, integrity, and authenticity are the features of the digital signature. If the electronic document is changed by an unauthorized signer, the value of the digital signature of the electronic document would change subsequently.

The digital signature uses a Message-Digest 5 (MD5) algorithm and a public key cryptogram algorithm to encrypt and decrypt electronic documents. The MD5 algorithm is used for transforming the electronic document into a fixed-length character string that is usually 128 bit, 160 bit, 256 bit, and 512 bit, in order to shorten the length of the digital signature and improve the digital signature efficiency.

The public key cryptogram algorithm (such as RSA and ECC), also known as asymmetry algorithm, is used for encrypting and decrypting electronic documents with different keys. The signers of both sides have a pair of keys (a public key and a private key). The public key accessible to each other and is used for verifying the identity of the signer when the receiver receives the digital signature. The private key is kept hidden and is used for the digital signature. A digital certificate includes a public key, a private key, signer information, and so on, which are issued by an authoritative third-party organization.

The art of automatically signing electronic documents is disclosed in patents such as China Pat. No. 03822034.2, entitled “Method for Generating and/or Verifying a digital signature.” This invention can be utilized to automatically sign an electronic document by a signer thereby yielding a digital signature, and verify the digital signature (i.e., the identity of the signer) by the receiver. However, the identity verification is executed by the other side (i.e., the receiver) after the digital signature is signed (i.e., when the other side receives the digital signature), there is no identity verification before the digital signature is signed.

Therefore, what is needed is a system and method for automatically signing electronic documents, which can verify signer identity before the digital signature is signed, and prevent the forgery of the digital signature.

### SUMMARY OF THE INVENTION

A system for automatically signing electronic documents is provided in accordance with a preferred embodiment. The system includes a central computer, a database, and a certificate server connected with the database. The database is configured for storing digital certificates, and the certificate server is configured for distributing digital certificates, each digital certificate comprises a corresponding private key.

The central computer includes an electronic document creating module, an identity verifying module, a message digest generating module, and a message digest encrypting module. The electronic document creating module is configured for creating an electronic document, and notifying a signer to digitally sign the electronic document. The identity verifying module is configured for obtaining a copy of a digital certificate of the signer from the database, and verifying the identity of the signer according to the copy of the digital certificate. The message digest generating module is configured for generating a message digest of the electronic document if the identity of the signer has been verified. The message digest encrypting module is configured for encrypting the message digest with the corresponding private key thereby yielding a digital signature of the electronic document.

A computer-based method for automatically signing electronic documents is also provided. The method includes the steps of: creating an electronic document, and notifying a specified signer to digitally sign the electronic document; confirming whether or not to digitally sign the electronic document; obtaining a copy of a digital certificate of the specified signer if it is confirmed to digitally sign the electronic document, the digital certificate comprising a private key; verifying the identity of the specified signer according to the digital certificate; generating a message digest of the electronic document if the identity of the specified signer has been verified; and encrypting the message digest with the private key thereby yielding a digital signature of the electronic document.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram of a hardware configuration of a system for automatically signing an electronic document in accordance with a preferred embodiment;

FIG. 2 is a schematic diagram showing function modules of a central computer of the system of FIG. 1; and

FIG. 3 is a flowchart of a preferred method for automatically signing an electronic document, in accordance with one embodiment.

### DETAILED DESCRIPTION OF THE INVENTION

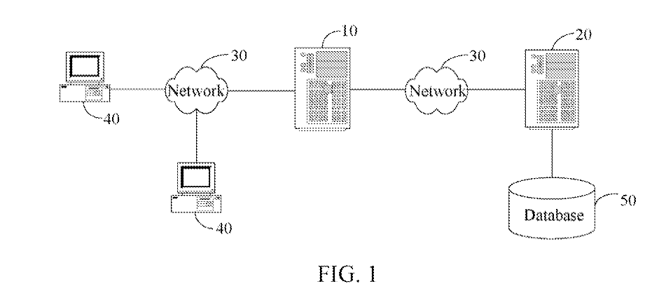

FIG. 1 is a schematic diagram of a hardware configuration of a system for automatically signing an electronic document (hereinafter, “the system”) in accordance with a preferred embodiment. The system includes a central computer 10, a certificate server 20, one or more user computers 40, and a database 50 connected with the certificate server 20. The central computer 10 is connected with the certificate server 20 and the user computers 40 through a network 30. Each of the user computers 40 is associated with one or more specific users. The network 30 is a data network for exchanging data among the central computer 10, the certificate server 20, and the user computers 40. The network 30 may be, for example, an internet protocol (IP) network which enables a communication between the central computer 10 and the user computers 40 through a transport control protocol-internet protocol (TCP-IP) stack.

The certificate server 20 is configured (i.e., structured and arranged) for generating public keys and private keys, verifying an application for a digital certificate from a potential signer, and for distributing a digital certificate to the potential signer if the application is approved. The digital certificate may include personal information of the signer, a public key, a private key, and an effective period of the digital certificate itself. A copy of the digital certificate is also kept in the database 50.

The personal information may contain a name, an E-mail address of the signer, a digital signature authority, and so on. The public key is accessible to each other and is used for verifying the identity of the signer before the digital signature is signed. The private key is always kept hidden and is used for encrypting a message digest of an electronic document thereby yielding the digital signature of the electronic document.

The central computer 10 is configured for creating the electronic document, verifying the identity of the signer according to the digital certificate obtained from the database 50, generating a message digest of the electronic document, encrypting the message digest according to a private key in the digital certificate thereby yielding a digital signature of the electronic document.

The digital signature systems runs in the central computer 10 and the user computers 40. The digital signature system in the user computers 40 provides a user interface to log in and perform digital signature operations, whereas the digital signature system in the central computer 10 provides a function of background processing including verifying identities of the users, and processing the digital signature operations thereby yielding digital signatures.

The embodiment can be illustrated by an example as follows. A user (i.e., a signer) sends a digital certificate application to the certificate server 20 for verification of the application. If the application is approved, the certificate server 20 distributes a digital certificate to the user, and stores a copy of the digital certificate in the database 50. If the central computer 10 creates the electronic document, the central computer 10 notifies a signer to digitally sign the electronic document. At first, the signer logs in to the digital signature system in the user computers 40, and confirms whether or not to digitally sign the electronic document. If the signer decides to digitally sign the electronic document, the central computer 10 obtains the copy of the digital certificate of the signer from the database 50 through the network 30, verifies the identity of the signer according to the copy of the digital certificate, and digitally signs the electronic document if the identity of the signer has been verified.

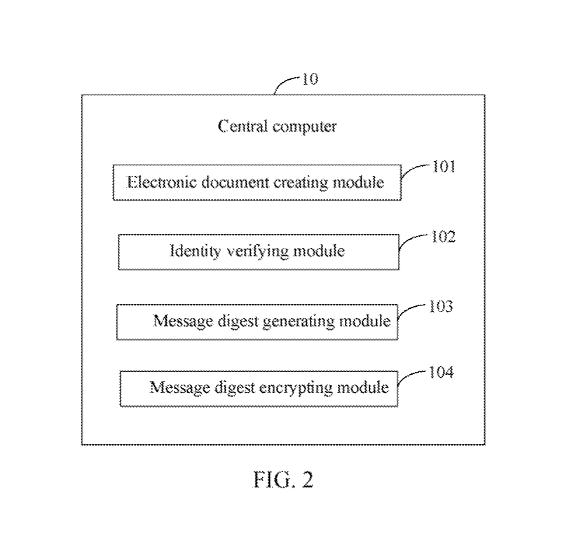

FIG. 2 is a schematic diagram showing function modules of the central computer 10. From functional point of view, the central computer 10 includes an electronic document creating module 101, an identity verifying module 102, a message digest generating module 103, and a message digest encrypting module 104.

The electronic document creating module 101 is configured (i.e., structured and arranged) for creating the electronic document, and notifying the signer to digitally sign the electronic document. The identity verifying module 102 is configured for obtaining the copy of the digital certificate of the signer from the database 50 if the signer decides to digitally sign the electronic document, and verifying the identity of the signer according to the copy of the digital certificate. The copy of the digital certificate includes the personal information of the signer, a public key, a private key, and an effective period of the digital certificate itself. The identity verifying module 102 determines that the identity of the signer is valid if the following requirements are all satisfied: the signer information includes the digital signature authority of the signer, the digital certificate includes the public key, and the effective period is in the effective range.

The message digest generating module 103 is configured for generating a message digest of the electronic document if the identity of the signer has been verified. The message digest is generated by transforming the electronic document into a fixed-length character string according to a MD5 algorithm. The message digest encrypting module 104 is configured for encrypting the message digest with the private key thereby yielding a digital signature of the electronic document.

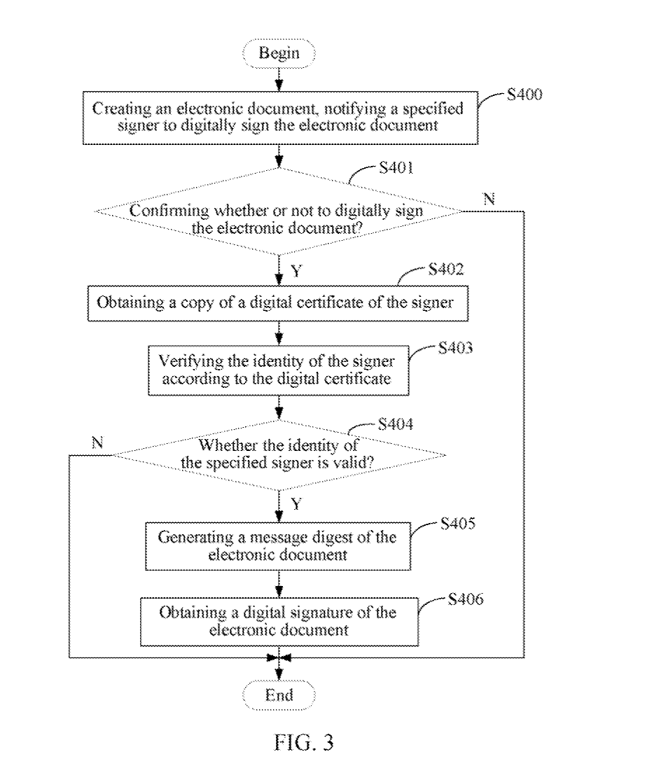

FIG. 3 is a flowchart of a preferred method for automatically signing an electronic document. In step S400, the electronic document creating module 101 creates an electronic document, and notifies a specified signer to digitally sign the electronic document through the network 30.

In step S401, if the specified signer receives the notification, the specified signer logs in to the digital signature system and replies whether or not to digitally sign the electronic document.

If the specified signer decides to digitally sign the electronic document, in step S402, the identity verifying module 102 obtains the copy of the digital certificate of the specified signer from the database 50.

In step S403, the identity verifying module 102 verifies the identity of the specified signer according to the digital certificate.

In step S404, the identity verifying module 102 verifies whether the identity of the specified signer is valid. The copy of the digital certificate includes the personal information of the signer, the public key, the private key, and the effective period. The identity verifying module 102 verifies that the identity of the specified signer is valid if the following requirements are all satisfied: the signer information includes the digital signature authority of the specified signer, the digital certificate includes the public key, and the effective period is in the effective range.

If the identity of the specified signer has been verified, in step S405, the message digest generating module 103 generates the message digest of the electronic document by transforming the electronic document into a fixed-length character string according to the MD5 algorithm as mentioned above.

In step S406, the message digest encrypting module 104 encrypts the message digest with the private key thereby yielding the digital signature of the electronic document.

If the identity of the specified signer cannot be verified or if the specified signer responds not to digitally sign the electronic document, the procedure ends.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for automatically signing an electronic document, the system comprising a central computer, a database, and a certificate server connected with the database, the certificate server being configured for distributing digital certificates each comprising a corresponding private key, the database being configured for storing digital certificates, the central computer comprising:
an electronic document creating module configured for creating an electronic document, and notifying a signer to digitally sign the electronic document;
an identity verifying module configured for obtaining a copy of a digital certificate of the signer from the database, and verifying the identity of the signer according to the copy of the digital certificate;
a message digest generating module configured for generating a message digest of the electronic document if the identity of the signer has been verified; and
a message digest encrypting module configured for encrypting the message digest with the corresponding private key thereby yielding a digital signature of the electronic document.

2. The system according to claim 1, wherein each of the digital certificates further includes personal information of the signer, a corresponding public key, and an effective period of the digital certificate itself.

3. The system according to claim 2, wherein the identity of the signer is valid if the identity verifying module verifies that the signer information includes the digital signature authority of the signer, the digital certificate includes the public key, and the effective period falls in the effective range.

4. The system according to claim 1, wherein the message digest is generated by transforming the electronic document into a fixed-length character string.

5. A computer-based method for automatically signing an electronic document, the method comprising the steps of:
creating an electronic document, and notifying a specified signer to digitally sign the electronic document;
confirming whether or not to digitally sign the electronic document;
obtaining a copy of a digital certificate of the specified signer if it is confirmed to digitally sign the electronic document, the digital certificate comprising a private key;
verifying the identity of the specified signer according to the digital certificate;
generating a message digest of the electronic document if the identity of the specified signer has been verified; and
encrypting the message digest with the private key thereby yielding a digital signature of the electronic document.

6. The method according to claim 5, wherein the digital certificate further includes personal information of the signer, a public key, and an effective period of the digital certificate itself.

7. The method according to claim 6, wherein the identity of the specified signer is determined to be valid if the signer information includes the digital signature authority of the specified signer, the digital certificate includes the public key, and the effective period is in the effective range.

8. The method according to claim 5, wherein the message digest is generated by transforming the electronic document into a fixed-length character string.
